(19) United States
(12) Patent Application Publication
(10) Pub. No.: US 2020/0286077 A1
(43) Pub. Date: Sep. 10, 2020

(54) Payment And Enforcement System For Electric Vehicle Charging Stations

(71) Applicant: Clear Token, Inc., Denver, CO (US)

(72) Inventors: Lawrence Berman, Delray Beach, FL (US); Stanley J. Wolfson, Denver, CO (US)

(21) Appl. No.: 16/881,739

(22) Filed: May 22, 2020

Related U.S. Application Data
(63) Continuation-in-part of application No. 15/416,367, filed on Jan. 26, 2017.
Application No. 15/416,367 is a continuation-in-part of application No. 14/709,001, filed on May 11, 2015, now abandoned.
Application No. 15/416,367 is a continuation-in-part of application No. 15/099,465, filed on Apr. 14, 2016, now abandoned.
Application No. 15/099,465 is a continuation-in-part of application No. 14/709,001, filed on May 11, 2015, now abandoned.
Application No. 15/416,367 is a continuation-in-part of application No. 15/099,508, filed on Apr. 14, 2016, now abandoned.
Application No. 15/099,508 is a continuation-in-part of application No. 14/709,001, filed on May 11, 2015, now abandoned.
(60) Provisional application No. 61/992,260, filed on May 13, 2014.
(60) Provisional application No. 61/992,260, filed on May 13, 2014.
(60) Provisional application No. 61/992,260, filed on May 13, 2014.

(51) Int. Cl. G06Q 20/36; G06Q 20/42; G06Q 20/40; G06Q 20/38; G06Q 20/32; G06Q 20/10; H04W 12/08; B60L 53/30; B60L 53/66

(52) U.S. Cl. CPC G06Q 20/3674; G06Q 20/42; G06Q 20/401; G06Q 20/385; G06Q 20/3672; G06Q 2220/00; G06Q 20/105; H04W 12/08; B60L 53/305; B60L 53/665; G06Q 2240/00; G06Q 20/3226

(57) ABSTRACT

An example secure electronic payment and enforcement for an EV charging device includes a remote payment processor to confirm payment for charging at an EV charging device and issue a token to a user's mobile device. A wireless interface module at the EV charging device is configured to receive the token from the mobile device via a wireless communications protocol. A token processing module at the EV charging device confirms validity of the token. A processing module negotiates the token and enables charging by the EV charging device.

### CROSS REFERENCE TO RELATED APPLICATIONS

This application is a continuation-in-part (CIP) of U.S. patent application Ser. No. 15/416,367 filed Jan. 26, 2017, which is a continuation-in-part (CIP) of U.S. patent application Ser. No. 14/709,001 filed May 11, 2015 which claims the priority benefit of U.S. Provisional Patent Application No. 61/992,260 filed on May 13, 2014; and this application is a continuation-in-part (CIP) of U.S. patent application Ser. No. 15/099,465 filed Apr. 14, 2016 which is a continuation-in-part (CIP) of U.S. patent application Ser. No. 14/709,001 filed May 11, 2015 which claims the priority benefit of U.S. Provisional Patent Application No. 61/992,260 filed on May 13, 2014; and this application is a continuation-in-part (CIP) of U.S. patent application Ser. No. 15/099,508 filed Apr. 14, 2016 which is a continuation-in-part (CIP) of U.S. patent application Ser. No. 14/709,001 filed May 11, 2015 which claims the priority benefit of U.S. Provisional Patent Application No. 61/992,260 filed on May 13, 2014; all of these applications hereby incorporated by reference for all that is disclosed as though fully set forth herein.

This application is also related to U.S. Provisional Patent Application No. 61/951,875 titled “Secure payment system” of Stanley J. Wolfson, filed on Mar. 12, 2014 and corresponding U.S. patent application Ser. No. 14/645,196 filed on Mar. 11, 2015, and U.S. patent application Ser. No. 14/671,456 titled “Parking Meter Payment Device” of Berman, et al. filed on Mar. 27, 2015, each of which is hereby incorporated by reference for all that is disclosed as though fully set forth herein.

### BACKGROUND

Electric Vehicles (EVs) are becoming more commonplace, and with federal mandates for increasing fleet fuel efficiencies of the automakers, EVs will continue to gain in popularity. Unlike hybrid vehicles which run on both gas and battery, EVs are fully electric and need to be charged regularly. Currently, many public parking areas offer free EV charging. However, as EVs become more commonplace, owners of EVs will be required to pay for charging their EV.

While EV charging stations may implement payment systems similar to traditional vending machines and parking meters, society is moving towards electronic payment via wireless devices including for example, mobile phones and other electronic devices. While these transactions can be easily implemented in an online environment, and even in attended environment with an attendant available to assist customers and/or reduce the occurrence of fraud (e.g., data processing and so-called “skimming” of credit card information), EV charging stations may lack an attendant. Even if an attendant is available, self-serve is often faster and preferred. Although traditional credit card payment systems may be provided in some locations, these may be subject to fraud and identity theft.

### BRIEF DESCRIPTION OF THE DRAWINGS

FIG. 1A shows an example payment and enforcement for electric vehicle (EV) charging stations.

FIG. 1B shows an example app interface executing on a mobile device.

FIG. 2 is a high-level diagram of a token processor of the secure payment and enforcement.

FIG. 3 illustrates an example coding scheme to build a token at a token processor.

FIG. 4 illustrates an example coding scheme to validate a token and process a transaction at an EV charging station.

FIG. 5 is a flow chart illustrating example operations of an EV charging station to implement a secure payment method.

FIG. 6 is an illustration of an example secure payment and enforcement implemented by an EV charging facility.

FIG. 7 is a block diagram of an example secure payment and enforcement for an EV charging facility.

FIG. 8 is a block diagram of a token handler of the secure payment and enforcement for an EV charging facility.

FIG. 9 shows an example EV charging device.

FIG. 10 is a flowchart illustrating example operations which may be implemented to process a secure payment by an EV charging device.

### DETAILED DESCRIPTION

Today enforcement almost does not exist as 85% of all EV chargers are free. We believe this era of none payment is about to end. The system disclosed herein may be implemented in new EV chargers and/or by retrofitting existing EV chargers to enhance the ability to collect payment to enforce compliance.

By adding the system disclosed herein to EV chargers (existing and/or new devices), it not only creates a robust enforcement system, but also enables that equipment to pay for charging the vehicle by converting existing “free” EV chargers to have the functionality of collecting payment (e.g., similar to a parking meter), thus enabling the EV charge to be both a charger and parking meter and collect for both payments at the same time.

In an example, a green and red light is added to the EV charger to indicate visually to an enforcement agent that the unit has been paid and is not in violation. Signs may indicate the days of the week and time that parking is permitted. The sign may also indicate the duration of time permitted to park and charge a vehicle. The back-end software can be programmed to not permit piggyback parking (e.g., two sessions of parking, one after the other). By way of illustration, if a vehicle parks for 2 hours (as indicated by the sign) and then 5 minutes later after the 2 hours have expired and the user tries to park again, the user may be automatically denied further charging/parking privileges in the same spot, lot, or enforcement area. Cars that park in that space that are not totally electric can also be issued a violation automatically.

Secure electronic payment for electric vehicle (EV) charging stations is disclosed. In an example, secure electronic payment may be implemented to pay for use of an EV charging device using an electronic device such as, but not limited to, a mobile phone, without needing to have a physical credit card or traditional cash on hand. In an example, a user (e.g., a customer) may issue a request for a transaction at the EV charging device. The request is processed to confirm payment, and a token (e.g., a secure digital certificate such as an electronic data file) is issued to the customer.

The customer may then transmit (e.g., wirelessly transmit) the token to the EV charging device, whereupon the EV charging device validates the token and negotiates the transaction (e.g., adds time to the charging).

In an example, the user may execute the payment application on their mobile device to pay for EV charging and the parking fee at the same device.

In an example, the EV charger includes a large light indicator so that the user and parking enforcement can readily see the payment status for a vehicle parked in an EV charging space. For example, the light may be green when appropriate payment has been made. The light may change to red when a vehicle that is parked in the EV charging space is in violation for lack of payment, or has run out of time.

In an example, the payment duration can be configured so that over-payment and duration can be monitored and adjusted. So, for example, if a user wanted to charge their vehicle for one hour, but remain parked longer, this could be paid/configured by the user via the mobile device app. Then if the vehicle was still in the space after the parking time expired, a parking violation could be issued.

An example EV charging device implementing the secure payment and enforcement includes a wireless certificate reader configured to receive a digital certificate or “token” from a mobile computing device. In use, a mobile computing device (e.g., mobile phone) may include an installed application or “app”. When the mobile computing device is activated via the app, it searches for any EV charging devices in the area which may be operated with the digital payment and vending system. In an example, the app may display a list of such devices in the user's vicinity which accept payment via the secure payment and enforcement. In other examples, the customer may manually identify the EV charging device (e.g., by entering a device ID in the app).

It is noted that the wireless certificate reader does not need to establish a connection to the payment provider or other entity. As such, the EV charging device does not need to be configured with an expensive to install and maintain modem or other communications system. The wireless certificate reader can instead be a BLUETOOTH™ or other near-field communication protocol for communicating with the mobile computing device in proximity to the EV charging device.

In an example, data to validate the token received at the EV charging device is stored in the local memory of the EV charging device before a transaction is initiated at the EV charging device. As such, no communication connection is required between the digital payment and vending system and the third party payment system. This enables use of the digital payment and vending system without having to provide expensive communication connections in each EV charging device.

The token may be a one-time-use digital certificate. In an example, after the token has been confirmed and the transaction negotiated, the corresponding information stored in the EV charging device may be “wiped” clean (e.g., the code set to zero or otherwise erased). This helps ensure that the goods and/or services delivered by the EV charging device have been paid for and that the same digital certificate is not being re-used. In another example, the token may include an expiration, so that a customer cannot purchase tokens in advance to avoid price increases.

Of course, the secure payment and enforcement may be implemented with any EV charging device. The examples described herein are merely illustrative, and other applications will also become apparent to those having ordinary skill in the art after becoming familiar with the teachings herein.

In an example, the secure payment and enforcement may operate with a third-party payment processor to handle payments for the user without the user having to provide any credit card or other form of payment (or personal or other information) to the secure payment and enforcement. For example, the user may have already provided payment information (e.g., credit card or bank account information) to the third-party payment processor, who is a trusted payment processor such as the user's bank, credit card issuer, direct carrier billing (e.g., billing to a cell phone account), digital currency, or other payment service, and therefore the user does not have to provide any payment information to the EV charging device (or anyone associated with the EV charging device). As such, the secure payment and enforcement reduces the occurrence for fraud, while providing the user with convenience of a so-called “cashless” transaction. Likewise, the owner of the EV charging device receives payment from a trusted third-party payment processor without risk that the payment form (e.g., credit card) is stolen or unauthorized.

It is noted that the systems and methods described herein are not limited to any particular type of EV charging device, mobile device, and/or payment processor. The EV charging device may be used in an attended and/or unattended environment.

Before continuing, it is noted that as used herein, the terms “includes” and “including” mean, but is not limited to, “includes” or “including” and “includes at least” or “including at least.” The term “based on” means “based on” and “based at least in part on.”

The term “token” as it refers to a type of “digital certificate” (or “electronic information” or “data packet”) is intended to broadly designate data or information provided by the system to a mobile device, which may or may not be further processed by the mobile device, and which is capable of being processed in conjunction with data or information provided at the EV charging device to verify or otherwise confirm payment.

It is also noted that the examples described herein are provided for purposes of illustration, and are not intended to be limiting. Other devices and/or device configurations may be utilized to carry out the operations described herein.

The operations shown and described herein are provided to illustrate example implementations. The operations are not limited to the ordering shown. Still other operations may also be implemented.

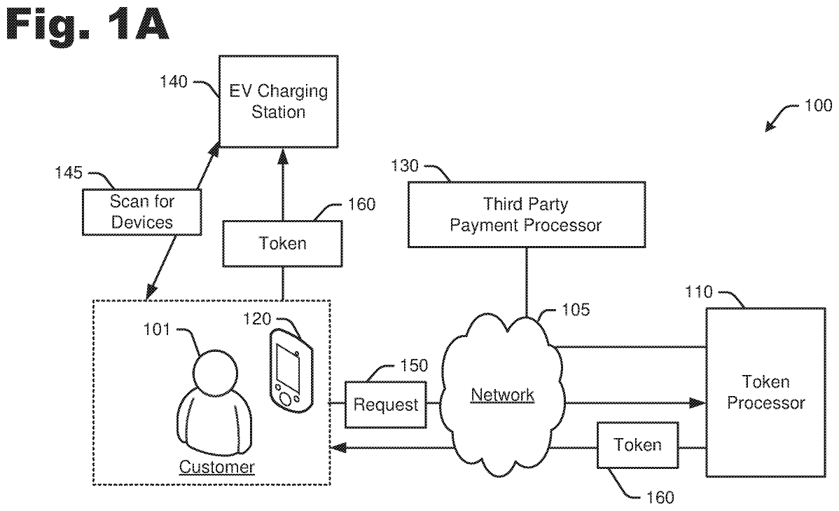

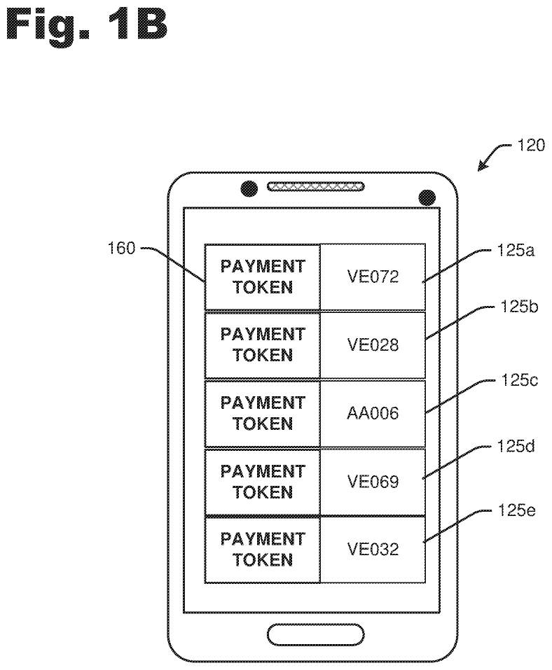

FIG. 1A shows an example payment and enforcement 100 for electric vehicle (EV) charging stations. System 100 may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other logic described herein.

In an example, the secure payment and enforcement 100 may be implemented by a token processor 110 providing a digital payment and EV charging accessed by a user 101 via a client device 120 (referred to herein collectively as the “customer”). The client device 120 may be any suitable computer or computing device (e.g., laptop computer or other mobile device such as a phone or tablet) capable of accessing a third party payment processor 130.

Of course, the token processor 110 and client device 120 are not limited to any particular type of devices (e.g., watches and other wearable technology), and may also include other devices that are traditionally not considered to be a part of the mobile environment (e.g., desktop computing devices or terminals).

In an example, the secure payment and enforcement 100 may be implemented with one or more communication network 105, such as a local area network (LAN) and/or wide area network (WAN) and/or other communications platform such as a mobile communications network. In an example, the network includes the Internet and/or other mobile communications network (e.g., a 3G or 4G mobile device network).

In an example, the secure payment and enforcement 100 provides a way for the user 101 to pay for the EV charging device 140, using the user's own mobile device 120, via the digital payment service implemented by the token processor 110, but without having to provide the EV charging device 140 with access to payment information maintained by third party payment processor(s) 130 (e.g., a bank or credit card company).

In use, a mobile device 120 (e.g., a mobile phone) may include an installed application or “app”. FIG. 1B shows an example app interface executing on a mobile device. When the mobile device 120 is activated via the app, the mobile device 120 searches 145 for any EV charging devices 140 in the area which are configured for operation in the environment of the secure payment and enforcement 100. In an example, the app may display a list of such device(s) 125a-e in the user's vicinity on the mobile device 120 which accept payment via the payment technique described herein.

In an example, the user may issue a request 150 to the token processor 110. The request 150 may include the EV charging device ID (e.g., a number shown on the vending machine) or other identifying information. The request 150 may also include other information about the intended purchase (e.g., parking time, product ID) and a payment authorization. For example, the amount of payment may be displayed for the user by the app for the user to accept or approve the item and amount. The user may then select a third party payment processor 130 (e.g., a bank, credit card, or mobile phone service carrier) from the app. This information may be transmitted in the request 150 to the token processor.

The token processor 110 then confirms payment via the third party payment processor 130. For example, the token processor 110 may issue a payment authorization to a third-party payment processor 130, and receive payment approval from the third-party payment processor. After confirming payment, the token processor 110 may generate a token 160 and issue the token 160 to the user's mobile device 120.

After receiving the token 160, the user may then complete the transaction at the EV charging device 140. In an example, the EV charging device 140 includes a wireless certificate reader configured to receive a token 160 from the mobile device 120. The token 160 may be the same token provided by the token processor 110, or token 160 may undergo at least some degree of processing at the mobile device 120 before being issued to the EV charging device 140.

The EV charging device 140 may then process the token 160 to confirm payment by the user 101. If payment is confirmed, then the EV charging device 140 may negotiate the transaction and commence charging.

As such, the system 100 provides a way for the user 101 to pay for charging offered by a EV charging device 140, using the user's own mobile device 120, but without having to provide the token processor 110 with access to payment details maintained by third party payment processor(s) 150 (e.g., a bank or credit card company).

In an example, various operations of the secure payment and enforcement 100 may be implemented at least in part by program code and/or logic circuitry explained by way of example in more detail in the related patent applications incorporated by reference herein. Therefore, the explanation of specific program code is not repeated again herein. Operation of the program code and/or logic used to implement features of the system can be better understood with reference to the following discussion and corresponding figures of various example functions. To the extent program code is implemented, machine-readable instructions may be stored on a non-transient computer readable medium and are executable by one or more processor to perform the operations described herein. Examples of program code may include an end-user mobile device application (or “app”), payment processing application(s), host application (e.g., for generating the token in response to receiving confirmation of payment), and/or an application for validating the token received from the end-user device). Of course, the operations described herein are not limited to any specific implementation with any particular type of program code or logic.

It is noted, however, that the secure payment and enforcement 100 is not strictly program code in the traditional sense. That is, the secure payment and enforcement 100 may be implemented at least in part in program code (e.g., for generating the token and for various of the transmission protocols). It is to be understood that the secure payment and enforcement 100 is also implemented by device hardware which goes beyond a mere computing device provided to execute the program code. Example device hardware may include a wireless certificate reader with a communications interface (e.g., to the mobile device). Example device hardware may also include a EV charging device with associated electronics operable to deliver charging in response to input from the wireless certificate reader and/or other processing device confirming payment for the EV charging device.

These and other aspects of the secure payment and enforcement 100 will be described in more detail below such that the device hardware can be readily implemented by one having ordinary skill in the art after becoming familiar with the teachings herein.

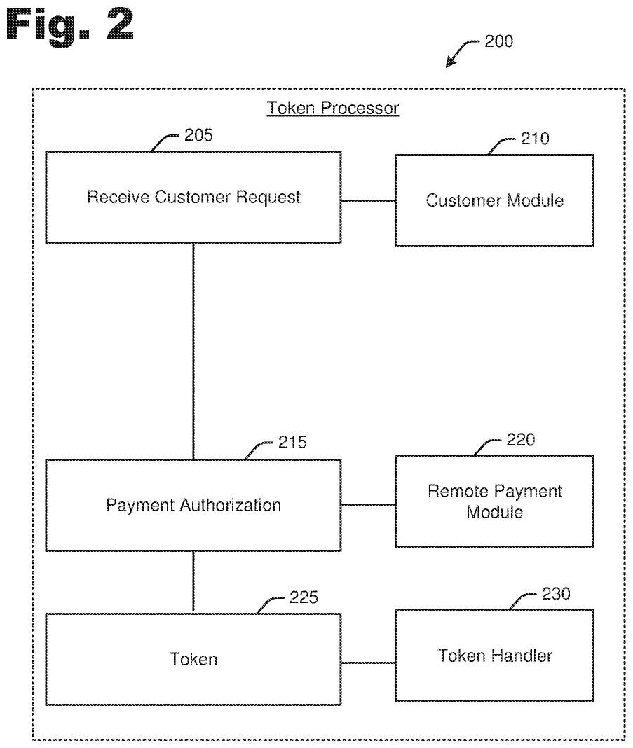

FIG. 2 is a high-level diagram of a token processor 200 (e.g., token processor 110 in FIG. 1A) of the secure payment and enforcement. The token processor 200 may receive a request 205 for a transaction (e.g., including a payment amount) at a EV charging device via a customer module 210. In an example, the request 205 may include information about the EV charging device (e.g., identifying information for the EV charging device). The token processor 200 issues a payment authorization 215 via a remote payment module 220 to a third-party payment processor. It is noted that the token processor does not actually receive any payment or other personal or confidential payment information from the customer. This information remains confidential as between the customer and the third party payment processor (e.g., the customer's bank or credit card processor). The token processor 200 receives payment approval from the third-party payment processor. The token processor 200 includes a token handler 230 to generate a token 225 and issues the token 225 to the customer so that the customer can complete the transaction at the EV charging device.

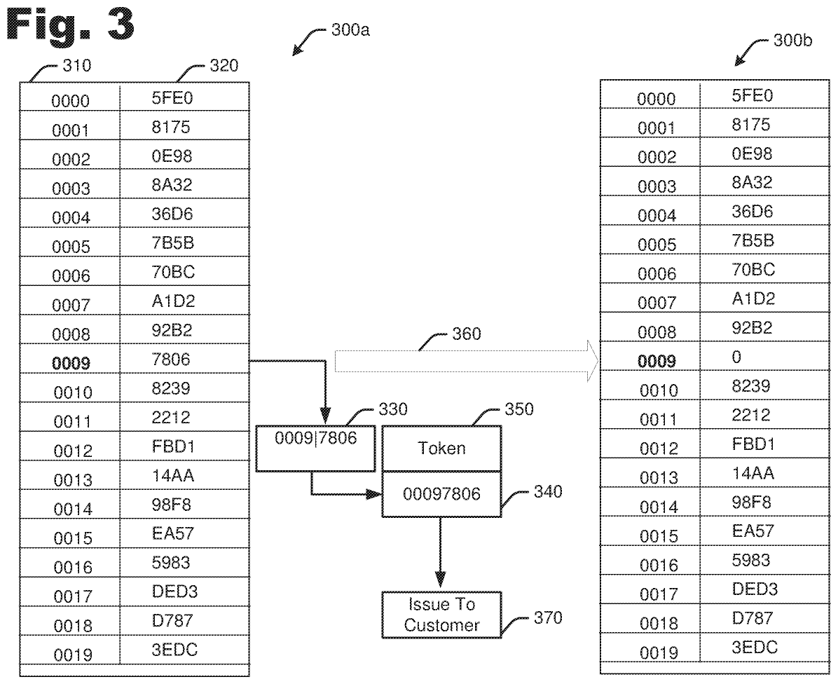

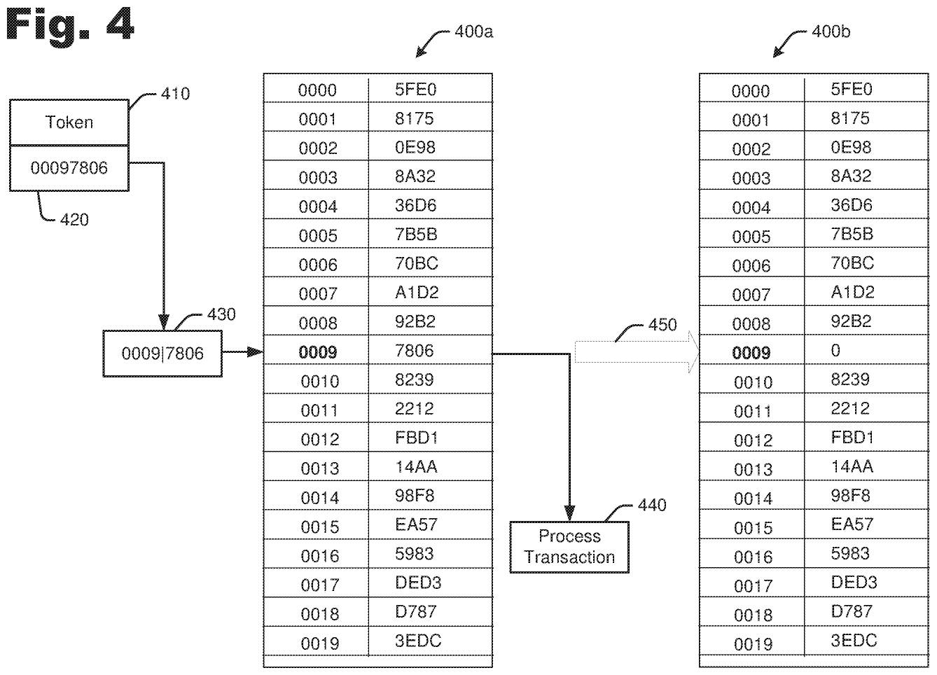

FIG. 3 illustrates an example coding scheme to build a token at a token processor. FIG. 4 illustrates an example coding scheme to validate a token and process a transaction at an EV charging station. The tables 300a-b in FIG. 3 and tables 400a-b in FIG. 4 illustrate a code sample (the first 20 entries of 65,536 entries are shown). The first column represents an index (1 through the number of entries), and the second column represents the corresponding code for the index entry. The codes shown in FIG. 3 may be stored at the token processor (e.g., token processor 110 shown in FIG. 1A) and used to generate the token. These same codes (shown in FIG. 4) may also be written to the EV charging device (e.g., EV charging device 140 in FIG. 1A) by “injecting” the codes in hardware stored in or associated with the EV charging device. Each EV charging device includes its own set of unique codes in an indexed array, stored in memory internally at the EV charging device.

During set up, the EV charging device may be read (e.g., for device ID or location number, and a corresponding code). The codes may be compared to a database record stored by the token processor. If there is a match, then the EV charging device has been properly set up, and is ready for use by the customer.

During use, the user may open a phone app and select the location or other ID of the EV charging device. The location or other ID of the EV charging device may be transmitted by nearby mobile devices (e.g., using Bluetooth or other communications protocol), or the user may manually enter the location or other ID. A request is generated on the user's mobile device, including the location and/or other information of the EV charging device(s). Additional information may also be included in the request, e.g., based on location type such as time for charge. The user may also select a payment processor (e.g., a bank, credit card processor, PayPal®, etc.) to be included in the request. The user may be prompted to use the last payment processor used or enter a new payment processor.

The request is sent to the token processor to authorize payment. The payment processor may charge the user's account and return “Approved” or “Declined” to the token processor. The digital payment service may notify the user (e.g., if payment was declined). But the token processor never receives personal or financial information or credit card information of the user.

If the payment is approved, then the token processor may build a token for the user to deliver to the EV charging device. In an example, the token may include a location code, duration or activation code, security code (FIG. 3), and optionally an advertisement or other information for the user to view. For example, the token processor may select transaction index (e.g., index location 0009) from the index column 410 and read a corresponding transaction code (e.g., hex 7806 representing decimal 30726) from the code column 420, as illustrated by the numbers 430 in FIG. 4. It is noted that any suitable system (e.g., alpha-numeric) may be used, and is not limited to a numbering system.

In this example, the numbers are in hexadecimal and added (e.g., as packet 340) to the token 350. The table 300a may be updated as illustrated by arrow 360 and shown as updated table 300b, wherein the code at index location 0009 is set to “0”. The token 350 may then be issued to the customer as illustrated by block 360.

The user may then relay the token 410 including the hexadecimal 420 to the EV charging device, as illustrated in FIG. 4. The EV charging device receives the token, and validates the transaction code in the token (FIG. 4), for example by reading the token packet 420 and comparing the index and hex code 430 with the corresponding index location 0009 of the device index. If the device code at index location 0009 in table 400a matches the transaction code in the token 410, the EV charging device may negotiate or process the transaction 440 by executing a device command (e.g., activate charging).

The EV charging device may also update/modify the table 400a stored at the EV charging device, as illustrated by arrow 450, to indicate that the code has been used (e.g., by setting the code in index 9 to all O's) as shown by updated table 400b in FIG. 4. As such, the index location 9 cannot be re-used, thereby preventing fraudulent use.

In this example, a small 128K file contains 65,536 unique codes. For a EV charging device being used an average of 5 times every day, the original codes are predicted to last about 39 years. For an EV charging device being use 20 times a day, the original codes are predicted to last about 9½ years. For a busy EV charging device being accessed 100 times a day, the original codes are predicted to last about 2 years. In the event that the codes need to be changed or updated, a secure update procedure may be implemented to refresh the codes in the field.

It should be understood that the systems and techniques described above may be modified within the scope of the disclosure herein, and are not limited to any particular implementation. For example, the example code and indexing illustrated in the figures is illustrative and not limiting.

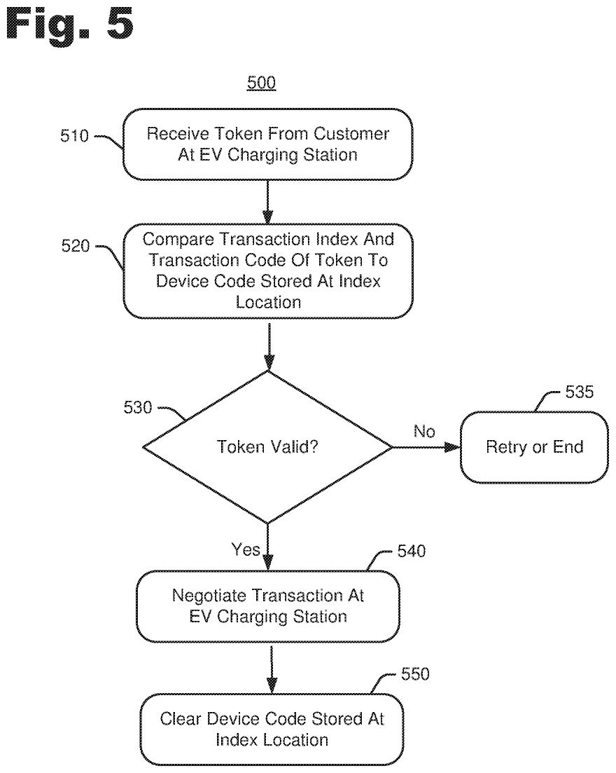

FIG. 5 is a flow chart illustrating example operations 500 of an EV charging station to implement a secure payment method. In operation 510, the EV charging device receives a token from the customer (e.g., the token issued to the customer by the token processor). The EV charging device may receive the token from the customer's mobile device via a BLUETOOTH™ or other near-field communication protocol. In an example, the token includes a hex value representing the transaction code and the transaction index.

In operation 520, the EV charging device compares the transaction index and transaction code of the token to a device code stored at corresponding index location at the EV charging device. For example, the EV charging device may translate the hex value to determine the transaction code and the transaction index, and then compare these to the corresponding device code stored at the associated index location at the EV charging device.

In operation 530, the EV charging device determines whether the token is valid. If the token is not valid, operations at the EV charging device may end with operation 535. In another example, the EV charging device may issue feedback to the user (e.g., to retry by sending a different token).

If the token is valid, the EV charging device may negotiate the transaction at operation 540. In an example where the EV charging device is a parking meter, the EV charging device may set (or add) a time duration for the customer to park in a designated parking space. In an example where the EV charging device is a vending machine, the EV charging device may dispense the purchased product. Other examples are also contemplated wherein the EV charging device is a point-of-sale device, point-of-entry, or other type of device.

In operation 550, the EV charging device clears the device code stored at the index location so that the token cannot be reused.

Example operations shown in FIG. 5 are illustrative and not intended to be limiting. The ordering of operations is not limited to the ordering shown in the drawings. Still other operations are also contemplated, as will become readily apparent to those having ordinary skill in the art after becoming familiar with the teachings herein.

In an example, the secure electronic payment may be implemented to pay for use of an EV charging device (e.g., a facility having multiple EV charging devices in a multi-space parking lot(s) or garage(s) and/or valet using the lot(s) or garage(s)). Payment is handled on-site by an electronic device such as, but not limited to, a mobile phone, without needing to have a physical credit card or traditional cash on hand. In an example, a user (e.g., a customer) may issue a request for a transaction for a EV charging device. The request is processed to confirm payment, and a token (e.g., a secure digital certificate such as an electronic data file) is issued to the customer.

The customer may then transmit (e.g., wirelessly transmit) the token to a token handler for the EV charging device. In an example, the token handler is provided on (or as an integral part of) a parking area access control device (e.g., a gate) for multiple EV charging devices. The token handler validates the token and negotiates the transaction, for example, by actuating operation of a gate or other parking area access control device to enable entry and/or exit of a vehicle from a designated parking area having the EV charging devices.

An example token handler includes a wireless certificate reader configured to receive a digital certificate or “token” from a mobile computing device. In use, a mobile computing device (e.g., mobile phone) may include an installed application or “app”. When the mobile computing device is activated via the app, it searches for any token handlers in the area (e.g., a EV charging facility having EV charging devices) which may be operated with the secure payment and enforcement system. In an example, the app may display a list of EV charging device in the user's vicinity which accept payment via the system. In other examples, the customer may manually identify the token handler (e.g., by entering an ID for a EV charging facility in the app).

In an example, where a EV charging facility with a valet or parking attendant implements the secure payment and enforcement, the user can pay securely without having to pay the individual valet or parking attendant. In addition, the owner or operator of the EV charging facility can retrieve EV charging device usage and availability reports, thereby enabling the owner to better understand customer needs.

It is noted that the wireless certificate reader does not need to establish a connection to the payment provider or other entity. As such, the token handler does not need to be configured with an expensive to install and maintain modem or other communications system. The wireless certificate reader can instead be a BLUETOOTH™ or other near-field communication protocol for communicating with the mobile computing device in proximity to the token handler.

In addition, the EV charging devices do not need to be in an area having mobile phone/data service. For example, the user may request a token at their home, and then use that token at an EV charging device that is out of a service area by providing it to the token handler for the EV charging facility via the BLUETOOTH™ or other near-field communication protocol.

In an example, data to validate the token received at the token handler is stored in the local memory of the token handler before a transaction is initiated at the token handler. As such, no communication connection is required between the secure payment and enforcement and the third party payment system. This enables use of the secure payment and enforcement without having to provide expensive communication connections by the EV charging facility.

The token may be a one-time-use digital certificate. In an example, after the token has been confirmed and the transaction negotiated (i.e., the EV charging device has been actuated), the corresponding information stored in the token handler may be “wiped” clean (e.g., the code set to zero or otherwise erased). This helps ensure that the goods and/or services delivered by the token handler have been paid for and that the same digital certificate is not being re-used. In another example, the token may include an expiration tag, so that a customer cannot purchase tokens in advance to avoid price increases.

In an example, the secure payment system may operate with a third-party payment processor to handle payments for the user without the user having to provide any credit card or other form of payment (or personal or other information) at the EV charging facility. For example, the user may have already provided payment information (e.g., credit card or bank account information) to the third-party payment processor, who is a trusted payment processor such as the user's bank, credit card issuer, direct carrier billing (e.g., billing to a cell phone account), digital currency, or other payment service, and therefore the user does not have to provide any payment information to the token handler or the token provider. As such, the secure payment and enforcement reduces the opportunity for fraud, while providing the user with the convenience of a so-called “cashless” transaction. Likewise, the owner of the EV charging facility receives payment from a trusted third-party payment processor without risk that the payment form (e.g., credit card) is stolen or unauthorized.

The secure payment and enforcement may support simple linear and/or complex dynamic rate structures. For example, the unit may charge higher prices during peak hours or overall electricity usage conditions (higher mid-day when air conditioning units are also running, and less at night when demand is lower).

The secure payment and enforcement may be implemented at EV charging facilities to accept a variable rate structure. In an example, the secure payment and enforcement can be pre-programmed or programmed on the fly for these types of changes to the rate that is charged. In addition, discounts may be offered (e.g., a coupon could be applied via the app). Indeed, even free charging may be offered.

The secure payment and enforcement also enables EV charging facilities to designate all or portions of an EV charging facility (e.g., designated for residents, guests, etc.).

The secure payment and enforcement also enables the user to extend charging without having to go back to the EV charging device or attendant. The time left is shown on the user's mobile phone. A warning message may be delivered to the user alerting the user that their paid for charging time is ending.

It is noted that the systems and methods described herein are not limited to any particular type of EV charging facility, mobile device, and/or payment processor. The secure payment and enforcement may be used in an attended and/or unattended environment, and may be used to enable operation of any type of EV charging facility.

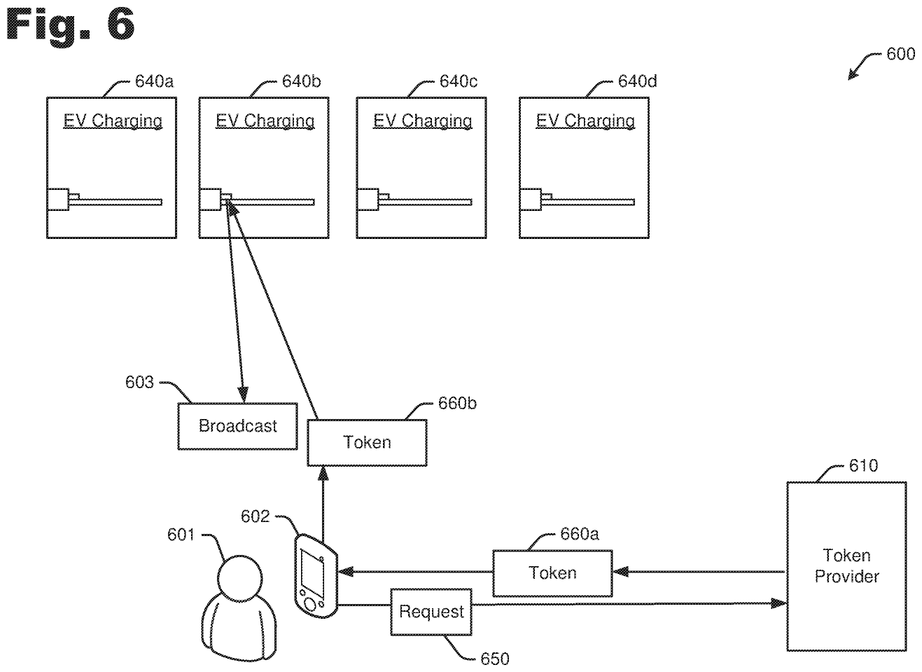

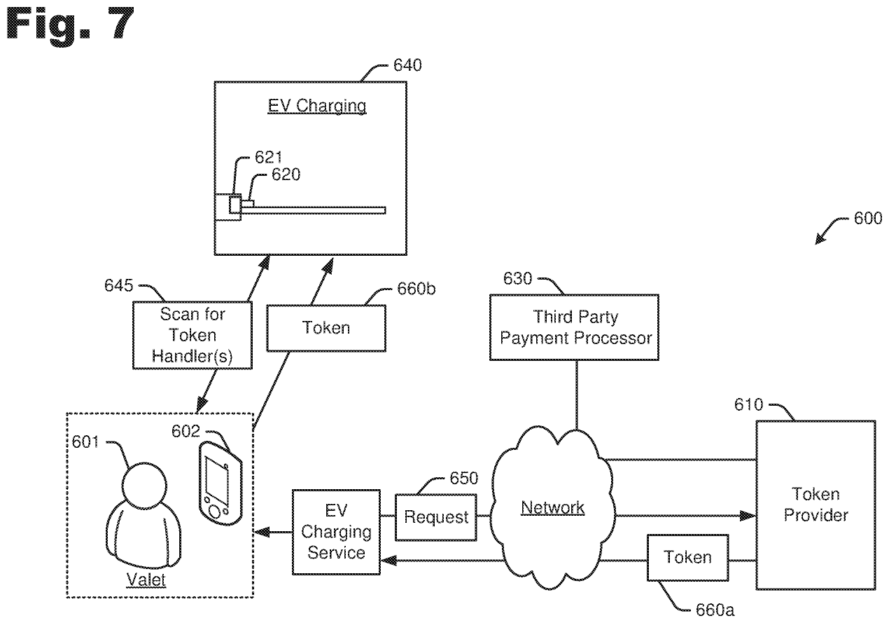

FIG. 6 is an illustration of an example secure payment and enforcement implemented by an EV charging facility 700. FIG. 7 is a block diagram of an example secure payment and enforcement for an EV charging facility 700. The payment and enforcement may be implemented with any of a wide variety of computing devices. Each of the computing devices may include memory, storage, and a degree of data processing capability at least sufficient to manage a communications connection either directly with one another or indirectly (e.g., via a network). At least one of the computing devices is also configured with sufficient processing capability to execute program code and/or other logic described herein.

In an example, the secure payment and enforcement may be implemented by a token provider 610 providing a digital payment service accessed by a user 601 via a client device 602. The user may be a customer (e.g., the owner of the vehicle to be charged), or a valet (e.g., a person authorized to charge a vehicle). The client device 602 may be any suitable computer or computing device (e.g., laptop computer or other mobile device such as a phone or tablet) capable of accessing a third party payment processor 630.

Of course, the token provider 610 and client device 602 are not limited to any particular type of devices (e.g., watches and other wearable technology), and may also include other devices that are traditionally not considered to be a part of the mobile environment (e.g., desktop computing devices or terminals).

In an example, the secure payment and enforcement may be implemented with one or more communication network, such as a local area network (LAN) and/or wide area network (WAN) and/or other communications platform such as a mobile communications network. In an example, the network includes the Internet and/or other mobile communications network (e.g., a 3G or 4G mobile device network).

In an example, the secure payment and enforcement provides a way for the user 601 to pay to charge at a EV charging devices 640a-d (referred to generally herein as EV charging facility 600), using the user's own mobile device 602, via the digital payment service implemented by the token provider 610, but without having to provide payment at the EV charging facility 600 because access to payment information is maintained by third party payment processor(s) 630 (e.g., a bank or credit card company).

In use, a mobile device 602 (e.g., a mobile phone) may include an installed application or “app”. When the mobile device 602 is activated via the app, the mobile device 602 searches 645 for any EV charging devices 640a-d at the facility 600 in the area which are configured for operation in the environment of the secure payment and enforcement. In an example, the EV charging facility 600 may broadcast 603 its presence. The mobile device 602 within range of the broadcast enables the app to display a list on the mobile device 602 of EV charging facilities in the user's vicinity which are configured to accept payment via the payment technique described herein. In another example, the identity of EV charging devices 640a-d may be pre-stored in a database accessed by the app via the Internet.

In an example, the user may issue a request 650 to the token provider 610. The request 650 may include the EV charging facility ID (e.g., a number shown at or near the EV charging facility) or other identifying information. The request 650 may also include other information about the intended purchase (e.g., EV charging facility location and time of use) and a payment authorization. For example, the amount of payment may be displayed for the user by the app for the user to accept or approve the item and amount. The user may then select a third party payment processor 630 (e.g., a bank, credit card, or mobile phone service carrier) from the app. This information may be transmitted in the request 650 to the token provider.

The token provider 610 then confirms payment via the third party payment processor 630. For example, the token provider 610 may issue a payment authorization to a third-party payment processor 630, and receive payment approval from the third-party payment processor. After confirming payment, the token provider 610 may generate a token 660a and issue the token 660 to the user's mobile device 602.

After receiving the token 660a, the user may then complete the transaction by the token handler 620 for the selected EV charging device 640a-d. In an example, the EV charging devices 640a-d are configured with a token handler operatively associated with a control board for the EV charging device (e.g., configured to select a charge time). The token handler may have a wireless certificate reader configured to receive a token 660b from the mobile device 602. The token 660a and 660b may be the same token provided by the token provider 610, or token 660b may undergo at least some degree of processing at the mobile device 602 before being issued to the token handler for the EV charging device.

The token handler at the EV charging device 640a-d may then process the token 660b to confirm payment by the user 601. If payment is confirmed, then the token handler for the EV charging device 640a-d may negotiate the transaction (e.g., opening a gate to enable access to a parking area).

As such, the system provides a way for the user 601 to pay for use of the EV charging facility, using the user's own mobile device 602, but without having to provide direct access to payment details because those are maintained by third party payment processor(s) 650 (e.g., a bank or credit card company).

In an example, various operations of the secure payment and enforcement may be implemented at least in part by program code and/or logic circuitry. Program code and/or logic used to implement features of the system can be better understood with reference to the following discussion and various example functions. To the extent program code is implemented, machine-readable instructions may be stored on a non-transient computer readable medium and are executable by one or more processor to perform the operations described herein. Examples of program code may include an end-user mobile device application (or “app”), payment processing application(s), host application (e.g., for generating the token in response to receiving confirmation of payment), and/or a token handling application (e.g., for validating the token received from the end-user device). Of course, the operations described herein are not limited to any specific implementation with any particular type of program code or logic.

It is noted, however, that the secure payment and enforcement is not strictly data handling or program code for manipulating data in the traditional sense. That is, the secure payment and enforcement may be implemented at least in part in program code (e.g., for generating the token and for various of the transmission protocols). It is to be understood that the secure payment and enforcement is also implemented by device hardware which goes beyond a mere computing device provided to execute the program code. Example device hardware may include a wireless certificate reader with a communications interface (e.g., to the mobile device). Example device hardware may also include electronic actuators and/or motors to operate a gate or other access control device, timers, and/or other electronics operable in response to input from the wireless certificate reader and/or other processing device confirming payment.

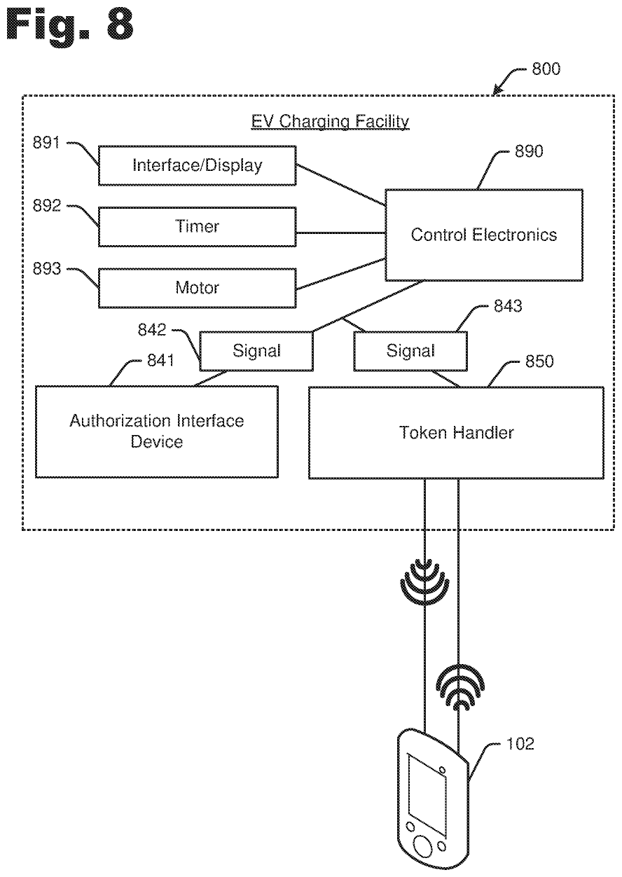

FIG. 8 is a block diagram of a token handler of the secure payment and enforcement for an EV charging facility. For example, the EV charging facility 800 may be implementing the EV charging facility payment device.

In an example, the existing authorization interface 841 generates an electrical signal 842 or pulse in response to receiving coins or other authorization (e.g., a bill acceptor or card reader). For example, each quarter may generate an electrical pulse thereby indicating a total dollar amount at the control electronics 890. For example, each time a user inserts a quarter, an electrical pulse is issued to the control electronics and the total dollar amount entered is displayed for the user (e.g., $0.25, $0.50, etc.) until the dollar amount is displayed for the desired function.

In an example, the token handler 850 is configured to generate an electrical pulse for each token received by the token handler, or multiple electrical pulses for the total dollar value of the token. For example, the token handler 850 may generate individual electrical pulses for each $0.25 token received. Or if a token is received having a value of $1.25, the token handler 850 may generate five electrical pulses to inform the control electronics 890 of the dollar value received. Parking can then be authorized similarly to the user inserting coins in the existing authorization interface 841, for example, by operating a gate or other access control device, or simply displaying “PAID”.

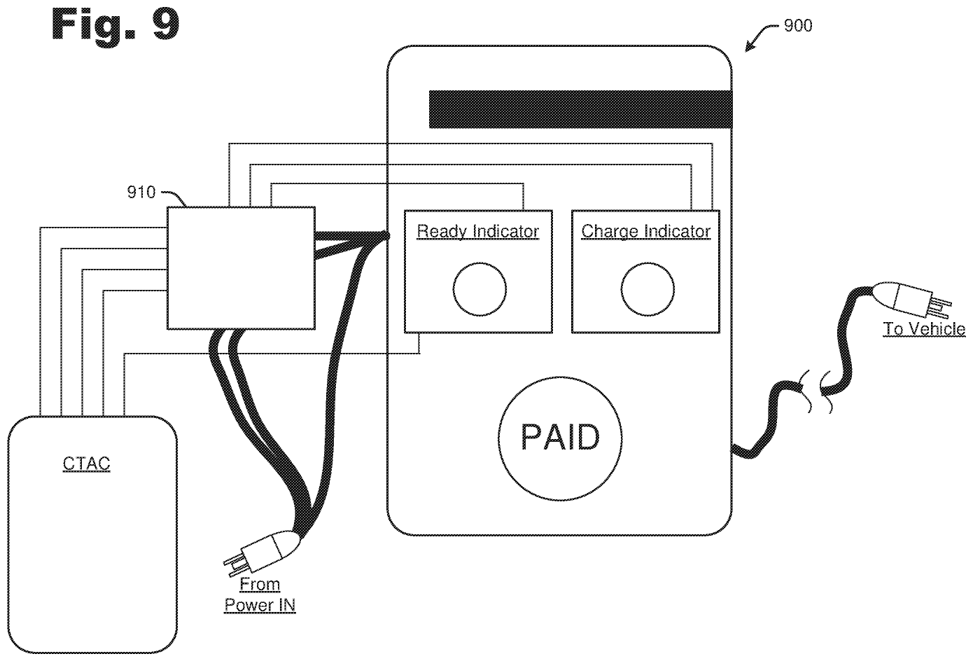

FIG. 9 shows an example EV charging device 900 with secure payment and enforcement installed. In an example, the EV charging device 900 is configured specifically for use with the secure payment and enforcement described herein. In another example, the EV charging device 900 has an existing payment or authorization interface (e.g., coin-operated, bill-operated, or card reader), and is retrofitted with the token handler device disclosed herein. In an example, retrofitting the token handler device may enable operation by either the existing authorization interface and/or via the token handler electronics 910. For example, the token handler electronics 910 may be wired into the existing authorization interface. In an example, the token handler electronics 910 is connected between the authorization interface and the charging control electronics of the EV charging device 900 without having to cut the existing wiring, e.g., by a coupler that splices through the wire insulation to make an electrical connection with the wiring by press-fit without having to cut the wires.

During operation, the token handler electronics 910 prevent the flow of electric charge from the Power Source (Power IN) to the vehicle unless and until payment is confirmed. Various indicators may be provided on the EV charging device 900, e.g., so that the user can see that the charging is active, that charging has been paid for, etc.

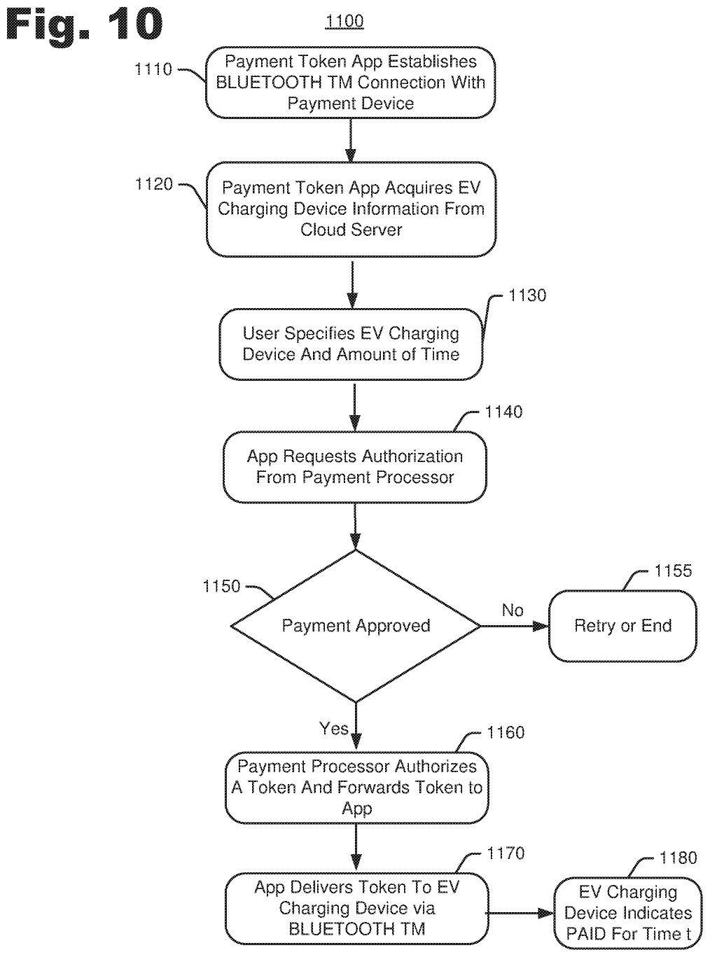

FIG. 10 is a flowchart illustrating example operations 1100 which may be implemented to process a secure payment by an EV charging device. In operation 1110, the payment token app (e.g., executed on the user's mobile device) establishes a connection (e.g., BLUETOOTH™) with the EV charging device. In operation 1120, the payment token app acquires payment device information from a cloud server. In operation 1130, the user specifies the EV charging device and optionally an amount of time to pay for charging. Other parameters may also be specified and/or selected on the app. In operation 1140, the app requests authorization from the payment processor. In operation 1150, the payment approval is either denied (in which case the user may retry or end operations at 1155) or approved. If approved, in operation 1160, the payment processor authorizes and issues a token to the app. The app delivers the token to the EV charging device in operation 1170 (e.g., via a local protocol communication such as via BLUETOOTH™). The EV Charger device indicates that the charging has been paid for in operation 1180 (e.g., for a predetermined time t).

It is noted that the examples shown and described are provided for purposes of illustration and are not intended to be limiting. Still other examples are also contemplated.

1. A secure electronic payment and enforcement method for an electric vehicle (EV) charging device, comprising:
receiving a request from a user's mobile device to pay for parking at an EV charging device;
confirming payment for charging at the EV charging device via a third-party payment processor, the third-party payment processor physically remote and independent from the EV charging device;
issuing a token to the user's mobile device separate from the EV charging device, the token having a transaction index and a transaction code, the transaction code corresponding to a device code already stored at an index location at the EV charging device identified by the transaction index;
receiving the token from the user's mobile device at a wireless interface of the EV charging device via a wireless communications protocol;
confirming validity of the token received from the user's mobile device at the EV charging device; and
beginning charging at the EV charging device in response to confirming the validity of the token.

2. The method of claim 1, further comprising retrieving identifying information for the EV charging device based on the request.

3. The method of claim 1, wherein confirming payment comprises:
issuing a payment authorization to the third-party payment processor; and
receiving payment approval from the third-party payment processor.

4. The method of claim 1, further comprising clearing the device code at the index location at the EV charging device so that the token cannot be reused.

5. The method of claim 1, further comprising executing a device command at the EV charging device to begin charging if the token is valid.

6. The method of claim 1, wherein the transaction code in the token is a hex value, and the device code in the EV charging device is a hex value, wherein the hex values must match to validate the token at the EV charging device.

7. A secure electronic payment and enforcement for an EV charging device configured to receive a token from a user's mobile device for charging a vehicle via the EV charging device, the EV charging device further configured to confirm validity of the token by a token processing module based on a transaction index and a transaction code of the token matching the device code already stored at an index location at the EV charging device identified by the transaction index in the token, and in response to a valid token, the EV charging device configured to begin charging the vehicle.

8. The system of claim 7 further comprising a remote payment module to confirm payment for the transaction and issue the token to the mobile device, the token having the transaction index and the transaction code.

9. The system of claim 8, wherein the remote payment module receives identifying information of the EV charging device from the request.

10. The system of claim 8, wherein the remote payment module confirms payment by:
issuing a payment authorization to a third-party payment processor; and
receiving payment approval from the third-party payment processor.

11. The system of claim 10, wherein the remote payment module confirms payment without receiving confidential payment information.

12. The system of claim 7, wherein the EV charging device confirms validity of the token by comparing the transaction index and the transaction code of the token to a device code corresponding to an index location stored at the EV charging device.

13. The system of claim 12, wherein the EV charging device clears the device code at the index location stored at the EV charging device so that the token cannot be reused.

14. The system of claim 13, wherein the device code stored at the EV charging device is refreshed via a secure field procedure to add new device codes.

15. The system of claim 7, wherein the transaction code in the token is a hex value, and the device code in the EV charging device is a hex value, wherein the hex values must match to validate the token at the EV charging device.

16. A secure electronic payment and enforcement for an EV charging device, comprising:
a remote payment processor to confirm payment for charging at an EV charging device and issue a token to a user's mobile device, the token having a transaction index and a transaction code, the transaction code corresponding to a device code already stored at an index location at the EV charging device identified by the transaction index;
a wireless interface module at the EV charging device configured to receive the token from the mobile device via a wireless communications protocol;
a token processing module at the EV charging device to confirm validity of the token based on the transaction index and the transaction code of the token matching the device code already stored at the index location at the EV charging device identified by the transaction index; and
a processing module to negotiate the token and enable charging at the EV charging device.

17. The system of claim 16, wherein the remote payment processor is configured to issue a payment request to a third-party payment processor, and receive payment approval from the third-party payment processor.

18. The system of claim 16, wherein the token processing module of the EV charging device confirms validity of the token by comparing the transaction index and the transaction code of the token to a device code stored at an index location at the EV charging device.

19. The system of claim 16, wherein the token processing module of the EV charging device clears the device code stored at the index location of the EV charging device after negotiating the transaction so that the token cannot be reused.

20. The system of claim 16, wherein the transaction processing module actuates charging by the EV charging device.
